(19) United States
(12) Patent Application Publication
(10) Pub. No.: US 2026/0019212 A1
(43) Pub. Date: Jan. 15, 2026

(54) SIGNALING FOR PARTIAL PORT SOUNDING PROCEDURES

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/261,768

(22) Filed: Jul. 7, 2025

Related U.S. Application Data
(60) Provisional application No. 63/669,335, filed on Jul. 10, 2024.

(51) Int. Cl. H04L 5/00; H04B 17/309; H04W 8/22; H04W 72/20; H04W 76/20

(52) U.S. Cl. CPC H04L 5/0051; H04B 17/346; H04W 8/22; H04W 72/20; H04W 76/20

(57) ABSTRACT

Methods, systems, and devices for wireless communications are described. A user equipment (UE) may transmit a capability message indicating that the UE is capable of performing a partial port sounding procedure via a first quantity of antenna ports that is less than a second quantity of antenna ports for a full port sounding procedure associated with a total set of antenna ports of the UE. The UE may receive a control signal instructing the UE to perform the partial port sounding procedure using a first subset of antenna ports of the UE, where the control signal identifies the first subset of antenna ports from the total set of antenna ports according to the first quantity of antenna ports. In response to the control signal, the UE may perform the partial port sounding procedure and deactivating a subset of receive chains using the first subset of antenna ports.

### CROSS REFERENCE

The present application for patent claims the benefit of U.S. Provisional Patent Application No. 63/669,335 by YANG et al., entitled “SIGNALING FOR PARTIAL PORT SOUNDING PROCEDURES,” filed Jul. 10, 2024, assigned to the assignee hereof, and which is expressly incorporated by reference herein.

### FIELD OF TECHNOLOGY

The following relates to wireless communications, including signaling for partial port sounding procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability message indicating that the UE is capable of performing a partial port sounding procedure via a first quantity of antenna ports that is less than a second quantity of antenna ports for a full port sounding procedure associated with a total set of antenna ports of the UE, receiving a control signal instructing the UE to perform the partial port sounding procedure using a first subset of antenna ports of the UE, where the control signal identifies the first subset of antenna ports from the total set of antenna ports according to the first quantity of antenna ports, and performing the partial port sounding procedure using the first subset of antenna ports in response to the control signal.

A UE for wireless communications is described. The UE may include one or more memories storing processor executable code, and one or more processors coupled with the one or more memories. The one or more processors may individually or collectively be operable to execute the code to cause the UE to transmit a capability message indicating that the UE is capable of performing a partial port sounding procedure via a first quantity of antenna ports that is less than a second quantity of antenna ports for a full port sounding procedure associated with a total set of antenna ports of the UE, receive a control signal instructing the UE to perform the partial port sounding procedure using a first subset of antenna ports of the UE, where the control signal identifies the first subset of antenna ports from the total set of antenna ports according to the first quantity of antenna ports, and perform the partial port sounding procedure using the first subset of antenna ports in response to the control signal.

Another UE for wireless communications is described. The UE may include means for transmitting a capability message indicating that the UE is capable of performing a partial port sounding procedure via a first quantity of antenna ports that is less than a second quantity of antenna ports for a full port sounding procedure associated with a total set of antenna ports of the UE, means for receiving a control signal instructing the UE to perform the partial port sounding procedure using a first subset of antenna ports of the UE, where the control signal identifies the first subset of antenna ports from the total set of antenna ports according to the first quantity of antenna ports, and means for performing the partial port sounding procedure using the first subset of antenna ports in response to the control signal.

A non-transitory computer-readable medium storing code for wireless communications is described. The code may include instructions executable by one or more processors to transmit a capability message indicating that the UE is capable of performing a partial port sounding procedure via a first quantity of antenna ports that is less than a second quantity of antenna ports for a full port sounding procedure associated with a total set of antenna ports of the UE, receive a control signal instructing the UE to perform the partial port sounding procedure using a first subset of antenna ports of the UE, where the control signal identifies the first subset of antenna ports from the total set of antenna ports according to the first quantity of antenna ports, and perform the partial port sounding procedure using the first subset of antenna ports in response to the control signal.

Some examples of the method, UEs, and non-transitory computer-readable medium described herein may further include operations, features, means, or instructions for receiving, in response to the capability message, a second control signal indicating one or more parameters for the UE to perform the partial port sounding procedure periodically or aperiodically.

Some examples of the method, UEs, and non-transitory computer-readable medium described herein may further include operations, features, means, or instructions for receiving, in response to the capability message, a second control signal instructing the UE to perform the full port sounding procedure using the total set of antenna ports of the UE periodically or aperiodically and performing the full port sounding procedure periodically or aperiodically using the total set of antenna ports of the UE based on the second control signal.

Some examples of the method, UEs, and non-transitory computer-readable medium described herein may further include operations, features, means, or instructions for receiving, via a third control signal, an indication of a first periodicity associated with performing the full port sounding procedure and of a second periodicity associated with performing the partial port sounding procedure.

In some examples of the method, UEs, and non-transitory computer-readable medium described herein, the third control signal includes a radio resource control (RRC) message.

Some examples of the method, UEs, and non-transitory computer-readable medium described herein may further include operations, features, means, or instructions for receiving, in response to performing the partial port sounding procedure, a second control signal instructing the UE to perform the partial port sounding procedure using a second subset of antenna ports of the UE, where the second subset of antenna ports includes at least one antenna port different than the first subset of antenna ports and performing the partial port sounding procedure using the second subset of antenna ports in response to the second control signal.

In some examples of the method, UEs, and non-transitory computer-readable medium described herein, performing the partial port sounding procedure may include operations, features, means, or instructions for muting a second subset of antenna ports of the UE, where the second subset of antenna ports may be disjoint from the first subset of antenna ports.

In some examples of the method, UEs, and non-transitory computer-readable medium described herein, performing the partial port sounding procedure may include operations, features, means, or instructions for deactivating a subset of receive chains of a set of multiple receive chains at the UE, where the subset of receive chains correspond to a second subset of antenna ports, where the second subset of antenna ports may be different than the first subset of antenna ports used for transmission of sounding reference signals (SRSs).

In some examples of the method, UEs, and non-transitory computer-readable medium described herein, receiving the control signal may include operations, features, means, or instructions for receiving the control signal instructing the UE to perform the partial port sounding procedure based on a downlink buffer size being below a threshold buffer size, a downlink throughput being below a threshold downlink throughput, or both.

In some examples of the method, UEs, and non-transitory computer-readable medium described herein, the first subset of antenna ports associated with the partial port sounding procedure may be based on an uplink signal-to-interference noise ratio (SINR) measurement per port associated with full port sounding.

In some examples of the method, UEs, and non-transitory computer-readable medium described herein, the first subset of antenna ports used for the partial port sounding procedure may be associated with a higher uplink SINR measurement than a second subset of antenna ports muted for the partial port sounding procedure.

In some examples of the method, UEs, and non-transitory computer-readable medium described herein, performing the partial port sounding procedure may include operations, features, means, or instructions for transmitting one or more uplink SRSs using the first subset of antenna ports.

In some examples of the method, UEs, and non-transitory computer-readable medium described herein, the full port sounding procedure may be associated with a first power level that may be higher than a second power level associated with the partial port sounding procedure.

Some examples of the method, UEs, and non-transitory computer-readable medium described herein may further include operations, features, means, or instructions for receiving a fourth control signal indicating to switch from the partial port sounding procedure to the full port sounding procedure or from the full port sounding procedure to the partial port sounding procedure, where the fourth control signal includes a physical downlink control channel (PDCCH) message or a medium access control (MAC)-control element (CE) message.

In some examples of the method, UEs, and non-transitory computer-readable medium described herein, the control signal includes one of a MAC-CE or a downlink control information (DCI) message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communication systems that support signaling for partial port sounding procedures in accordance with one or more aspects of the present disclosure.

FIG. 3 shows an example of a process flow that supports signaling for partial port sounding procedures in accordance with one or more aspects of the present disclosure.

FIGS. 4 and 5 show block diagrams of devices that support signaling for partial port sounding procedures in accordance with one or more aspects of the present disclosure.

FIG. 6 shows a block diagram of a communications manager that supports signaling for partial port sounding procedures in accordance with one or more aspects of the present disclosure.

FIG. 7 shows a diagram of a system including a device that supports signaling for partial port sounding procedures in accordance with one or more aspects of the present disclosure.

FIGS. 8 and 9 show flowcharts illustrating methods that support signaling for partial port sounding procedures in accordance with one or more aspects of the present disclosure.

### DETAILED DESCRIPTION

In some wireless communication systems, user equipments (UEs) may perform uplink sounding with a network entity by transmitting one or more sounding reference signals (SRSs). A UE may transmit the one or more SRS to the network entity via an uplink channel using one or more antenna ports of the UE. Based on measuring the SRSs, the network entity may estimate a channel quality of the uplink channel and may manage subsequent resource scheduling, beam management, and power control for the UE. In some examples, the UE may use all the antenna ports at the UE to perform the uplink sounding. As such, the UE may transmit an SRS from each antenna port of a full set of antenna ports at the UE. However, in some cases, transmitting SRSs using the full set of antenna ports at the UE may increase power consumption at the UE. Accordingly, the UE may transmit the SRSs using a subset of antenna ports of the UE. For example, the UE may mute antenna ports of the full set of antenna ports and deactivate corresponding receive chains to conserve power. However, the network entity may be unaware of the muted antenna ports at the UE. For example, the network entity may measure the muted antenna ports, thereby consuming processing baseband resources and energy unnecessarily.

As described herein, the network entity and the UE may exchange one or more messages to support transmission of SRSs using the subset of antenna ports of the UE and measurement of the SRSs in accordance with muted antenna ports by the network entity. For example, the UE may transmit a capability message indicating that the UE is capable of a partial port sounding procedure via a first quantity of antenna ports. The first quantity of antenna ports may be less than a second quantity of antenna ports used for a full port sounding procedure (e.g., using a total set of antenna ports of the UE). In other words, the UE may indicate, to the network entity, a capability to transmit SRSs using at least one fewer antenna port than the total set of antenna ports at the UE.

Based on receiving the capability message, the network entity may transmit one or more control signals to the UE associated with the sounding procedures. For example, the network entity may transmit a first control signal indicating a periodicity associated with performing the full port sounding procedure relative to the partial port sounding procedure. In other words, the network entity may indicate how often the UE is to perform the full port sounding procedure using the full set of antenna ports. The network entity may transmit a second control signal indicating a first subset of antenna ports of the UE to be used for the partial port sounding. For example, the second control signal may identify the first subset of antenna ports from the total set of antenna ports. The UE may perform the partial port sounding procedure using the first subset of antenna ports based on the first control signal, the second control signal, or both. Performing the partial port sounding procedure may include muting antenna ports excluded from the first subset of antenna ports, deactivating receive chains corresponding to the muted antenna ports, or both.

By using the first subset of antenna ports for sounding, compared to the full set of antenna ports, the UE may reduce power consumption. Additionally, by exchanging the first control signal and the second control signal, the network entity may reduce power consumption and baseband processing resources that may be used when measuring antenna ports muted by the UE as part of the partial port sounding procedure.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to signaling for partial port sounding procedures.

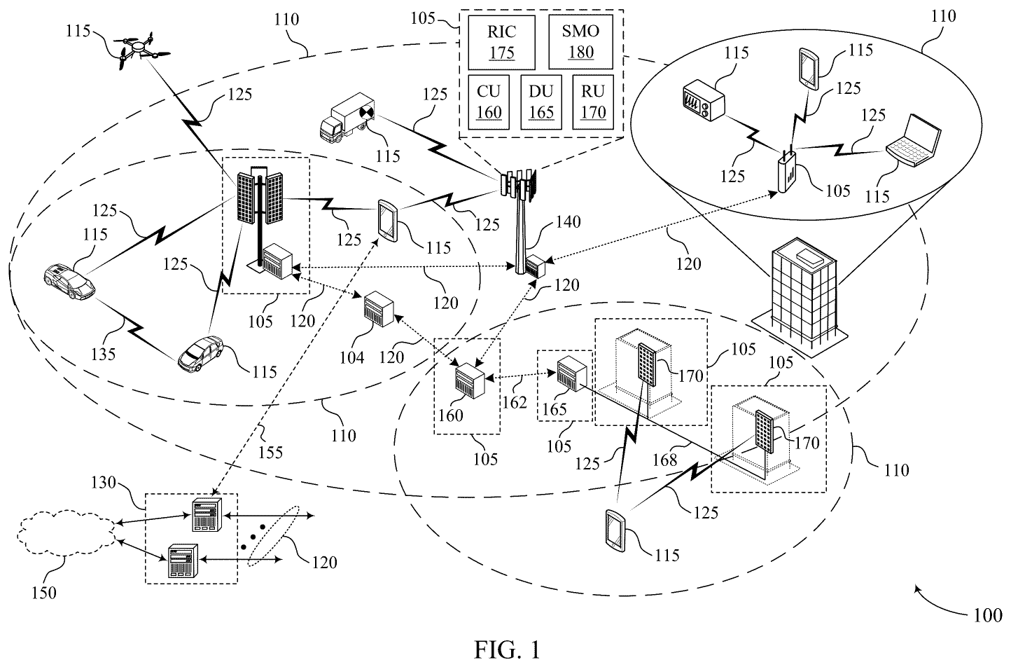

FIG. 1 shows an example of a wireless communications system 100 that supports signaling for partial port sounding procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, the UE 115 may perform a partial port sounding procedure based on exchanging one or more messages with the network entity 105. For example, the UE 115 may transmit a capability message indicating that the UE 115 is capable of performing a partial port sounding procedure via a first quantity of antenna ports that is less than a second quantity of antenna ports for a full port sounding procedure associated with a total set of antenna ports of the UE 115. In response to the capability message, the UE 115 may receive a control signal from the network entity 105 instructing the UE 115 to perform the partial port sounding procedure using a first subset of antenna ports of the UE 115. For example, the control signal may identify the first subset of antenna ports from the total set of antenna ports according to the first quantity of antenna ports (e.g., indicated in the capability message). The UE 115 may perform the partial port sounding procedure using the first subset of antenna ports in response to the control signal. That is, the UE 115 may perform the partial port sounding procedure based on receiving the control signal from the network entity 105.

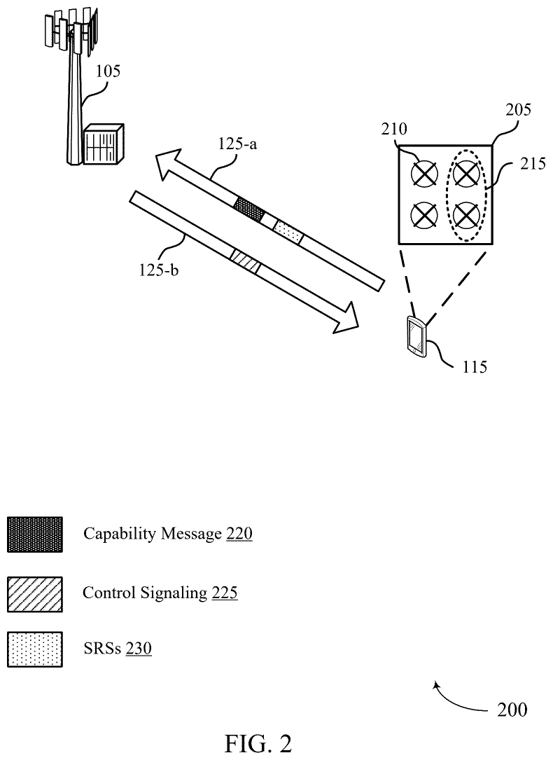

FIG. 2 shows an example of a wireless communications system 200 that supports signaling for partial port sounding procedures in accordance with one or more aspects of the present disclosure. In some examples, the wireless communications system 200 may implement or be implemented by the wireless communications system 100. For example, the wireless communications system 200 may include a network entity 105 and a UE 115 configured with an antenna panel 205 that includes antenna ports 210, which may represent examples of corresponding devices described herein with reference to FIG. 1. The network entity 105 may communicate with the UE 115 via an uplink communication link 125-a and a downlink communication link 125-b. The uplink communication link 125-a and the downlink communication link 125-b may be examples of a Uu link, a sidelink, a backhaul link, a D2D link or some other type of communication link 125 described with reference to FIG. 1.

In the wireless communications system 200, the network entity 105, the UE 115, or both may perform SRS-based downlink MIMO communications. For example, the network entity 105 may measure SRSs 230 transmitted by the UE 115 to determine one or more communications parameters associated with the MIMO communications. As an example, the network entity 105 may determine resource allocations, a communications schedule, or both based on measuring the SRSs 230 transmitted by the UE 115. In some cases, to conserve power at the UE 115, the UE 115 may mute a subset of the antenna ports 210 (e.g., 2 out of 4 SRS ports). The UE 115 may mute the subset of antenna ports 210 to request (e.g., implicitly) to be scheduled with 2-layer downlink MIMO communications (e.g., by the network entity 105). In accordance with being scheduled with the 2-layer downlink MIMO communications, the UE 115 may deactivate receive chains (e.g., 2 of 4 receive chains). For example, the UE 115 may deactivate a subset of receive chains to save power (e.g., reduce battery consumption) in examples in which the UE 115 has a relatively low amount of downlink traffic.

In some cases, the network entity 105 may be unaware of the subset of the antenna ports 210 muted by the UE 115. For example, the network entity 105 may measure (e.g., blindly) SRSs 230 from a full set of the antenna ports 210 of the UE 115 based on being unaware of which ports of the full set of antenna ports are muted. In such cases, the network entity 105 may use unnecessary processing resources and energy. Additionally, or alternatively, some network entities may have capabilities (e.g., processing limitations) to support SRS-based downlink MIMO for UEs having traffic exceeding a threshold (e.g., high traffic UEs), UEs in a cell with a quantity of UEs exceeding a threshold, or both. Without coordination between the network entity 105 and the UE 115, each device may be unaware of the antenna ports 210 expected to be muted in a partial port sounding procedure, resulting in degraded performance.

In the example of FIG. 2, the network entity 105 and the UE 115 may coordinate which of the antenna ports 210 are to be muted for the partial port sounding procedure. For example, the UE 115 may transmit a capability message 220 to the network entity 105. That is, the UE 115 may indicate a capability to perform the partial port sounding procedure (e.g., partial SRS sounding). In some examples, the UE 115 may indicate a quantity of ports capable of being used for the partial port sounding procedure. As an example, the capability message 220 may indicate that the UE 115 is capable of performing the partial port sounding procedure using a subset 215 of the antenna ports 210 including a quantity of the antenna ports 210.

The network entity 105 may enable and configure the partial port sounding procedure based on the capability message 220. For example, based on a downlink buffer size, a downlink throughput, or both, the network entity 105 may output control signaling 225 to indicate a quantity of the antenna ports 210, identify the antenna ports 210 of the antenna panel 205, or both to be muted for the partial port sounding procedure. In other words, the control signaling 225 may indicate the subset 215 of antenna ports 210 to be used for the partial port sounding procedure by the UE 115 (e.g., by indicating muted ports, used ports, or both). The control signaling 225 may be an example of a MAC-control element (CE) message, a downlink control information (DCI) message, or the like. In some examples, by indicating the antenna ports 210 to be muted, the control signaling 225 may indicate (e.g., implicitly) which receive chains are to be deactivated by the UE 115.

The network entity 105 may select the muted antenna ports based on uplink signal-to-interference noise ratio (SINR) measurements. For example, the network entity 105 may indicate to mute the antenna ports 210 associated with relatively low SINR measurements and indicate to use antenna ports 210 associated with relatively high SINR measurements. The network entity 105 may compare SINR measurements of each of the antenna ports 210 to a threshold to determine which ports to mute or use in the partial port sounding procedure. For example, the network entity 105 may determine to mute a first antenna port based on a SINR measurement of the first antenna port being below a SINR threshold, and the network entity 105 may determine to use a second antenna port in the partial port sounding procedure based on a SINR measurement of the first antenna port being above the SINR threshold.

The UE 115 may mute the antenna ports 210 based on the control signaling 225. For example, the UE 115 may perform the partial port sounding procedure using the subset 215 of the antenna ports 210 indicated by the network entity 105 in the control signaling 225. Additionally, the UE 115 may mute the remaining antenna ports (e.g., not in the subset 215) and deactivate (e.g., turn off) receive chains corresponding to the muted antenna ports. The UE 115 may transmit SRSs 230 via the antenna ports 210 of the subset 215 in accordance with the partial port sounding procedure. The network entity 105, based on the subset 215 indicated in the control signaling 225, may measure (e.g., measure a SINR of) the antenna ports 210 of the subset 215 (e.g., and refrain from measuring the muted antenna ports). Accordingly, the UE 115 and the network entity 105 may save power and reduce baseband processing resources.

The UE 115 may perform the full port sounding procedure using the full set of the antenna ports 210 at the UE 115 in addition to the partial port sounding procedure. For example, the network entity 105 may configure the UE 115 to perform the full port sounding procedure periodically. In such examples, the control signaling 225 may include a control signal indicating a periodicity associated with the full port sounding procedure. The control signal may be an example of an RRC message (e.g., a configuration or reconfiguration message). The control signal may indicate that the UE 115 is to perform the full port sounding procedure during transmit occasions (e.g., SRS transmit occasions). For example, the UE 115 may perform the partial port sounding procedure via the subset 215 of the antenna ports 210 (e.g., 2 out of 4 ports) every 20 slots. Additionally, the UE 115 may perform the full port sounding procedure via the full set of the antenna ports 210 every 100 slots. For example, the control signal may indicate that N=5, and the UE 115 is to perform the full port sounding procedure at a periodicity 5 times that of the partial port sounding procedure.

In some examples, the network entity 105 may update a quantity of the antenna ports 210, which of the antenna ports 210, or both are used for the partial port sounding procedure. For example, the network entity 105 may change the subset 215 based on measuring the antenna ports 210 of the UE 115 via the full port sounding procedure. As an example, the network entity 105 may identify a port which is muted during the partial port sounding procedure having a higher SINR than at least one port included in the subset 215, a SINR satisfying the threshold, or both. Accordingly, the network entity 105 may update the subset 215 to include the identified port.

In some examples, the subset 215 of the antenna ports 210 indicated via the control signaling 225 from the network entity 105 may include any combination of the antenna ports 210 available for the uplink sounding at the UE 115. For example, as illustrated within FIG. 2, there may be four of the antenna ports 210 available for uplink sounding and the subset 215 of antenna ports 210 to be sounded may include two of the antenna ports 210. However, it should be understood that the illustration of FIG. 2 is simply an example of one configuration and the subset 215 of the antenna ports 210 may include different antenna ports, a different quantity of the antenna ports 210, or both.

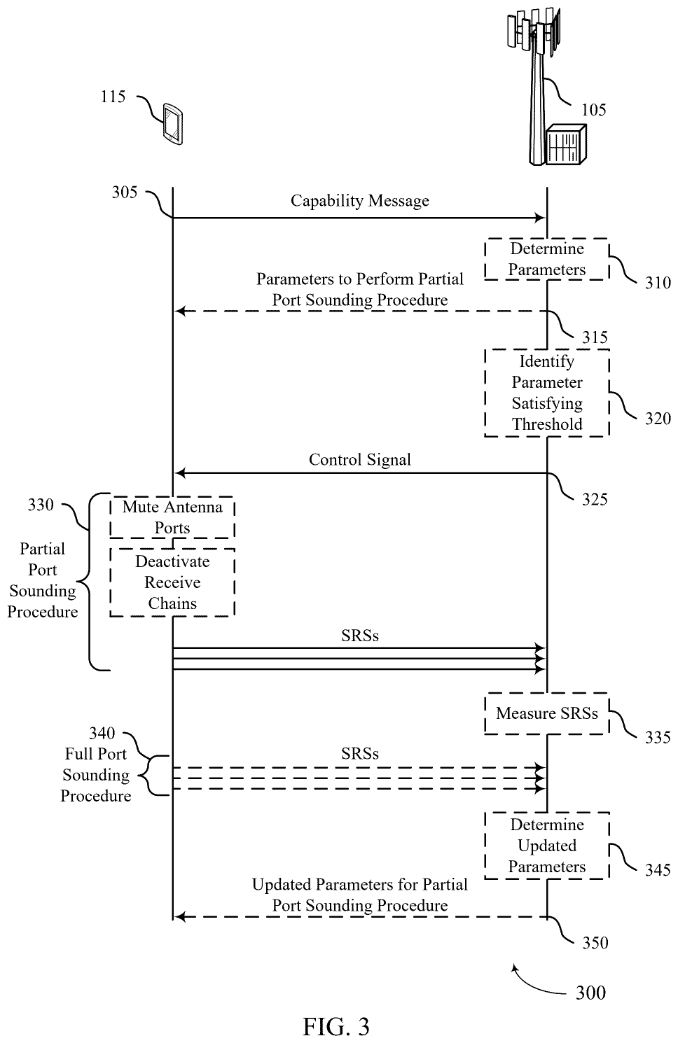

FIG. 3 shows an example of a process flow 300 that supports signaling for partial port sounding procedures in accordance with one or more aspects of the present disclosure. In some examples, the process flow 300 may implement or be implemented by the wireless communications system 100, the wireless communications system 200, or both. For example, the process flow 300 may include a UE 115 and a network entity 105, which may be examples of devices described herein with reference to FIGS. 1 and 2.

In the following description of the process flow 300, the operations between the UE 115 and the network entity 105 may be performed in different orders or at different times. Some operations may also be left out of the process flow 300, or other operations may be added. Although the UE 115 and the network entity 105 are shown performing the operations of the process flow 300, some aspects of some operations may also be performed by one or more other wireless devices.

At 305, the UE 115 may transmit a capability message to the network entity 105. For example, the UE 115 may transmit the capability message indicating that the UE 115 is capable of performing a partial port sounding procedure (e.g., a partial port SRS procedure) via a first quantity of antenna ports that is less than a second quantity of antenna ports for a full port sounding procedure (e.g., a full port SRS procedure) associated with a total set of antenna ports of the UE 115. In other words, the UE 115 may indicate a partial SRS capability. The capability message may be an example of the capability message 220 as described with reference to FIG. 2. Additionally, the total set of antenna ports of the UE 115 may be an example of the antenna ports 210 of the antenna panel 205 as described with reference to FIG. 2.

At 310, the network entity 105 may determine one or more parameters associated with the partial port sounding procedure. For example, the network entity 105 may determine a configuration for the partial port sounding procedure (e.g., partial port SRS procedure) based on the capability of the UE 115 received at 305. The parameters associated with the partial port sounding procedure may include a periodicity associated with a full port sounding procedure, a periodicity associated with a partial port sounding procedure, or both. For example, the network entity 105 may determine that 1/N transmit occasions (e.g., SRS transmit occasions) are to be performed via the total set of antenna ports, where the remaining

$$\frac{N - 1}{N}$$

transmit occasions are to performed via a subset of antenna ports.

At 315, the network entity 105 may output an indication of the one or more parameters associated with the partial port sounding procedure. For example, the UE 115 may receive, in response to the capability message, a control signal indicating one or more parameters for the UE 115 to perform the partial port sounding procedure. The control signal may be an example of an RRC signal (e.g., an RRC configuration or reconfiguration message). The control signal may enable or configure partial port sounding at the UE 115. For example, the control signal may configure a periodicity associated with the partial port sounding procedure, the full port sounding procedure, or both. Additionally, or alternatively, the control signal may instruct the UE 115 to perform the full port sounding procedure using the total set of antenna ports at the UE 115 periodically or aperiodically. In other words, the network entity 105 may indicate, via RRC signaling, how often the UE 115 is to perform the partial port sounding procedure, the full port sounding procedure, or both.

In examples in which an amount of downlink traffic is relatively high, the network entity 105 may reduce a periodicity associated with the partial port sounding procedure and increase a periodicity associated with the full port sounding procedure. Alternatively, in examples in which an amount of downlink traffic is relatively low, the network entity 105 may increase a periodicity associated with the partial port sounding procedure and decrease a periodicity associated with the full port sounding procedure (e.g., to reduce power consumption and improve battery life at the UE 115). In other words, the network entity 105 may adjust a relative frequency of partial or full port sounding based on traffic conditions at the UE 115, including a downlink throughput, for example.

At 320, the network entity 105 may identify that a parameter satisfies a threshold. For example, the network entity 105 may identify that a downlink buffer size is below a threshold buffer size, a downlink throughput is below a threshold downlink throughput, or both. Based on identifying that at least one of the downlink buffer size or the downlink throughput is below a corresponding threshold, the network entity 105 may transmit a control signal indicating a quantity of ports to be used for the partial port sounding procedure at the UE 115. In other words, the network entity 105 may output the control signal at 325 based on the downlink buffer size being below the threshold buffer size, the downlink throughput being below the threshold downlink throughput, or both.

At 325, the network entity 105 may output the control signal to the UE 115. For example, the UE 115 may receive the control signal instructing the UE 115 to perform the partial port sounding procedure using a first subset of antenna ports of the UE, where the control signal identifies the first subset of antenna ports from the total set of antenna ports according to the first quantity of antenna ports. In addition to or alternatively from identifying the first subset of antenna ports to use, the control signal may indicate a quantity of receive chains to be deactivated (e.g., receive chains corresponding to the first subset of antenna ports) for the partial port sounding procedure. The control signal may be an example of a MAC-CE or DCI message (e.g., dynamic signaling).

The network entity 105 may select the first subset of antenna ports based on one or more characteristics associated with the ports, such as based on an uplink SINR measurement per antenna port associated with a full port sounding procedure. In some examples, ports selected for the first subset of antenna ports may satisfy a threshold. That is, the network entity 105 may select a first antenna port for inclusion in the first subset of antenna ports based on the first antenna port satisfying a first threshold (e.g., a measurement threshold, such as a SINR threshold), a second antenna port for exclusion from the first subset of antenna ports (e.g., to be muted) based on the second antenna port satisfying the first threshold or a second threshold different than the first threshold. In other words, the network entity 105 may apply one or more thresholds for selecting ports to be used in the partial port sounding procedure, for selecting ports to be muted in the partial port sounding procedure, or both.

At 330, the UE 115 may perform a partial port sounding procedure. For example, the UE 115 may perform the partial port sounding procedure using the first subset of antenna ports in response to the control signal received at 325. Performing the partial port sounding procedure may include muting a second subset of antenna ports of the UE 115, where the second subset of antenna ports is disjoint from the first subset of antenna ports. In other words, the UE 115 may mute ports which are not used for the partial port sounding procedure (e.g., not in the first subset of antenna ports). Additionally, or alternatively, performing the partial port sounding procedure may include deactivating a subset of receive chains of multiple receive chains at the UE 115, where the subset of receive chains correspond to the second subset of antenna ports. In other words, the UE 115 may mute antenna ports excluded from the first subset of antenna ports and deactivate corresponding receive chains. Performing the partial port sounding procedure may include transmitting one or more uplink SRSs using the first subset of antenna ports. Performing the partial port sounding procedure, compared to a full port sounding procedure, may support energy saving at the UE 115. For example, by deactivating the receive chains (e.g., corresponding to the muted antenna ports), the UE 115 may save energy.

At 335, the network entity 105 may measure SRSs. For example, the network entity 105 may perform measurements based on the first subset of antenna ports used for the partial port sounding procedure by the UE 115. Performing the measurements in accordance with the first subset of antenna ports may support energy saving, reduced baseband processing resources, or both at the network entity 105. In other words, measuring a subset of antenna ports, rather than all of the antenna ports, may reduce a processing level at the network entity 105, thereby reducing energy consumption.

At 340, the UE 115 may perform the full port sounding procedure. For example, the UE 115 may perform the full port sounding procedure based on the periodicity indicated at 315. That is, the UE 115 may perform the full port sounding procedure after performing the partial port sounding procedure a quantity of times (e.g., N times). In some other examples, the UE 115 may perform the full port sounding procedure based on control signaling from the network entity 105 (e.g., dynamic signaling or indications). For example, the UE 115 may perform the full port sounding procedure at 340 based on receiving a control signal (e.g., a physical downlink control channel (PDCCH), MAC-CE, or DCI message) indicating to switch from the partial port sounding procedure to the full port sounding procedure. That is, the network entity 105 and the UE 115 may dynamically switch between partial and full port sounding procedures.

At 345, the network entity 105 may determine updated parameters. For example, the network entity 105 may determine an updated periodicity associated with the full port sounding procedure, an updated periodicity associated with the partial port sounding procedure, or both. For example, the network entity 105 may determine that 1/N transmit occasions (e.g., SRS transmit occasions) are to be performed via the total set of antenna ports, where the remaining

$$\frac{N - 1}{N}$$

transmit occasions are to be performed via a subset of antenna ports. Additionally, or alternatively, the network entity 105 may update the subset of antenna ports used for the partial port sounding procedure. For example, the network entity 105 may determine an updated subset of antenna ports based on an uplink SINR measurement per antenna port associated with the full port sounding procedure, such as the procedure performed at 340.

At 350, the network entity 105 may output the updated parameters for the partial port sounding procedure. For example, the UE 115 may receive the updated parameters and perform the partial port sounding procedure, the full port sounding procedure, or both based on the updated parameters. As an example, the UE 115 may receive, in response to performing the partial port sounding procedure at 330, a control signal instructing the UE 115 to perform the partial port sounding procedure using a second subset of antenna ports of the UE 115, where the second subset of antenna ports includes at least one antenna port different than the first subset of antenna ports. Additionally, or alternatively, the UE 115 may receive a control signal indicating updated periodicities associated with performing the partial port sounding procedure, the full port sounding procedure, or both. After receiving the updated parameters, the UE 115 may perform the partial port sounding procedure, the full port sounding procedure, or both based on the updated parameters.

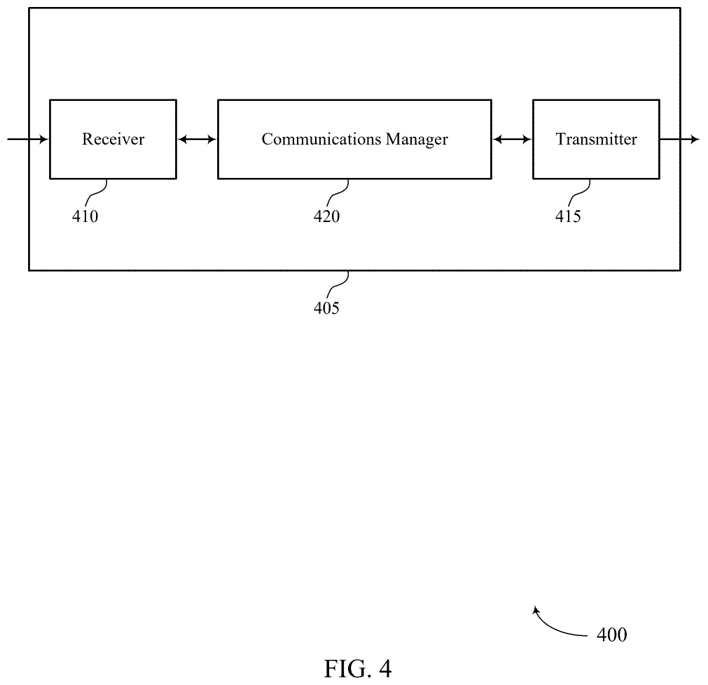

FIG. 4 shows a block diagram 400 of a device 405 that supports signaling for partial port sounding procedures in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to signaling for partial port sounding procedures). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to signaling for partial port sounding procedures). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of signaling for partial port sounding procedures as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a capability message indicating that the UE is capable of performing a partial port sounding procedure via a first quantity of antenna ports that is less than a second quantity of antenna ports for a full port sounding procedure associated with a total set of antenna ports of the UE. The communications manager 420 is capable of, configured to, or operable to support a means for receiving a control signal instructing the UE to perform the partial port sounding procedure using a first subset of antenna ports of the UE, where the control signal identifies the first subset of antenna ports from the total set of antenna ports according to the first quantity of antenna ports. The communications manager 420 is capable of, configured to, or operable to support a means for performing the partial port sounding procedure using the first subset of antenna ports in response to the control signal.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption.

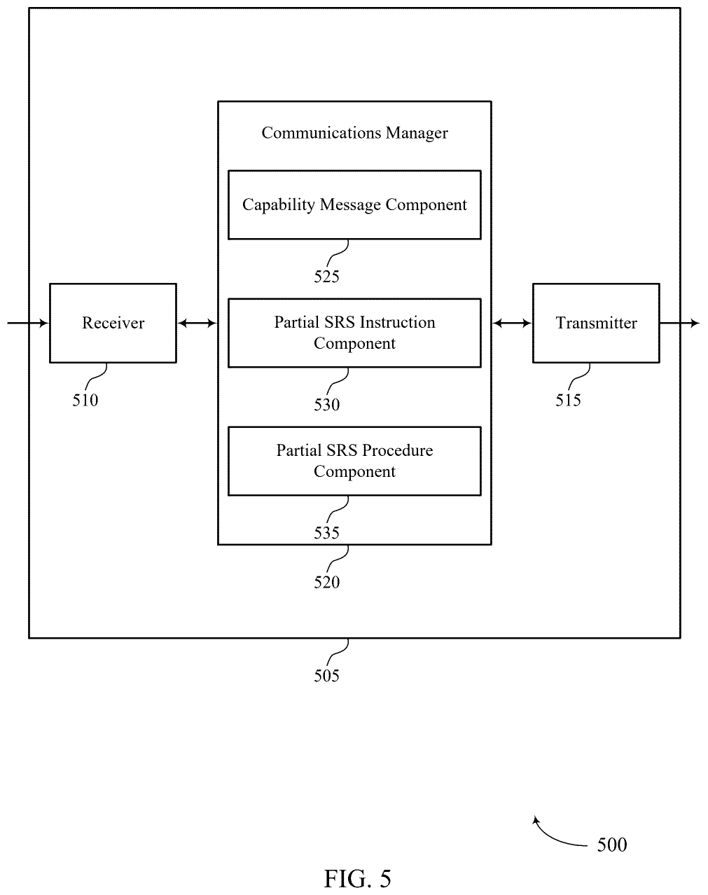

FIG. 5 shows a block diagram 500 of a device 505 that supports signaling for partial port sounding procedures in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to signaling for partial port sounding procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling for partial port sounding procedures). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of signaling for partial port sounding procedures as described herein. For example, the communications manager 520 may include a capability message component 525, a partial SRS instruction component 530, a partial SRS procedure component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability message component 525 is capable of, configured to, or operable to support a means for transmitting a capability message indicating that the UE is capable of performing a partial port sounding procedure via a first quantity of antenna ports that is less than a second quantity of antenna ports for a full port sounding procedure associated with a total set of antenna ports of the UE. The partial SRS instruction component 530 is capable of, configured to, or operable to support a means for receiving a control signal instructing the UE to perform the partial port sounding procedure using a first subset of antenna ports of the UE, where the control signal identifies the first subset of antenna ports from the total set of antenna ports according to the first quantity of antenna ports. The partial SRS procedure component 535 is capable of, configured to, or operable to support a means for performing the partial port sounding procedure using the first subset of antenna ports in response to the control signal.

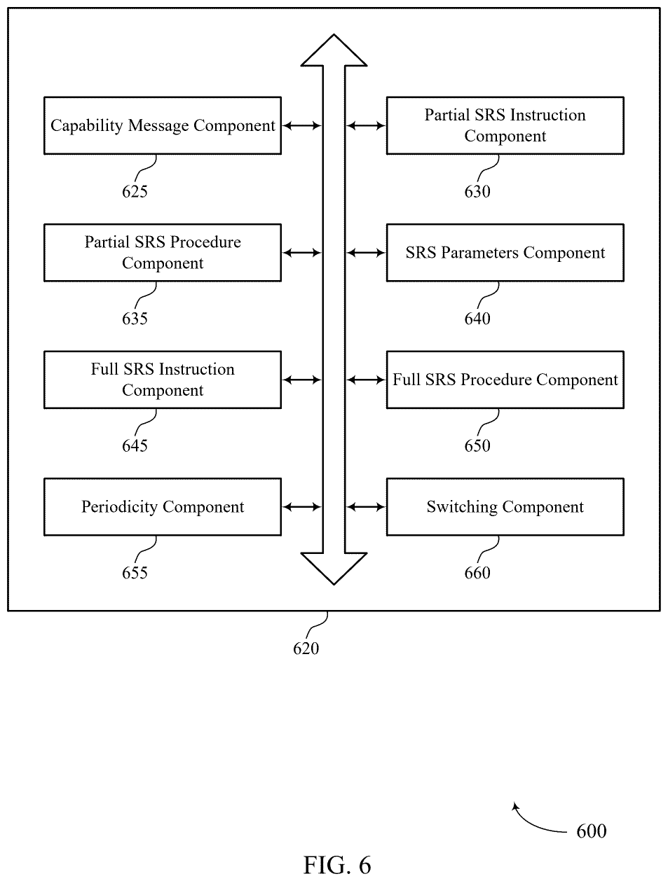

FIG. 6 shows a block diagram 600 of a communications manager 620 that supports signaling for partial port sounding procedures in accordance with one or more aspects of the present disclosure. The communications manager 620 may be an example of aspects of a communications manager 420, a communications manager 520, or both, as described herein. The communications manager 620, or various components thereof, may be an example of means for performing various aspects of signaling for partial port sounding procedures as described herein. For example, the communications manager 620 may include a capability message component 625, a partial SRS instruction component 630, a partial SRS procedure component 635, an SRS parameters component 640, a full SRS instruction component 645, a full SRS procedure component 650, a periodicity component 655, a switching component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The capability message component 625 is capable of, configured to, or operable to support a means for transmitting a capability message indicating that the UE is capable of performing a partial port sounding procedure via a first quantity of antenna ports that is less than a second quantity of antenna ports for a full port sounding procedure associated with a total set of antenna ports of the UE. The partial SRS instruction component 630 is capable of, configured to, or operable to support a means for receiving a control signal instructing the UE to perform the partial port sounding procedure using a first subset of antenna ports of the UE, where the control signal identifies the first subset of antenna ports from the total set of antenna ports according to the first quantity of antenna ports. The partial SRS procedure component 635 is capable of, configured to, or operable to support a means for performing the partial port sounding procedure using the first subset of antenna ports in response to the control signal.

In some examples, the SRS parameters component 640 is capable of, configured to, or operable to support a means for receiving, in response to the capability message, a second control signal indicating one or more parameters for the UE to perform the partial port sounding procedure periodically or aperiodically.

In some examples, the full SRS instruction component 645 is capable of, configured to, or operable to support a means for receiving, in response to the capability message, a second control signal instructing the UE to perform the full port sounding procedure using the total set of antenna ports of the UE periodically or aperiodically. In some examples, the full SRS procedure component 650 is capable of, configured to, or operable to support a means for performing the full port sounding procedure periodically or aperiodically using the total set of antenna ports of the UE based on the second control signal.

In some examples, the periodicity component 655 is capable of, configured to, or operable to support a means for receiving, via a third control signal, an indication of a first periodicity associated with performing the full port sounding procedure and of a second periodicity associated with performing the partial port sounding procedure.

In some examples, the third control signal includes an RRC message.

In some examples, the partial SRS instruction component 630 is capable of, configured to, or operable to support a means for receiving, in response to performing the partial port sounding procedure, a second control signal instructing the UE to perform the partial port sounding procedure using a second subset of antenna ports of the UE, where the second subset of antenna ports includes at least one antenna port different than the first subset of antenna ports. In some examples, the partial SRS procedure component 635 is capable of, configured to, or operable to support a means for performing the partial port sounding procedure using the second subset of antenna ports in response to the second control signal.

In some examples, to support performing the partial port sounding procedure, the partial SRS procedure component 635 is capable of, configured to, or operable to support a means for muting a second subset of antenna ports of the UE, where the second subset of antenna ports is disjoint from the first subset of antenna ports.

In some examples, to support performing the partial port sounding procedure, the partial SRS procedure component 635 is capable of, configured to, or operable to support a means for deactivating a subset of receive chains of a set of multiple receive chains at the UE, where the subset of receive chains correspond to a second subset of antenna ports, where the second subset of antenna ports are different than the first subset of antenna ports used for transmission of SRSs.

In some examples, to support receiving the control signal, the partial SRS instruction component 630 is capable of, configured to, or operable to support a means for receiving the control signal instructing the UE to perform the partial port sounding procedure based on a downlink buffer size being below a threshold buffer size, a downlink throughput being below a threshold downlink throughput, or both.

In some examples, the first subset of antenna ports associated with the partial port sounding procedure are based on an uplink SINR measurement per port associated with full port sounding.

In some examples, the first subset of antenna ports used for the partial port sounding procedure are associated with a higher uplink SINR measurement than a second subset of antenna ports muted for the partial port sounding procedure.

In some examples, to support performing the partial port sounding procedure, the partial SRS procedure component 635 is capable of, configured to, or operable to support a means for transmitting one or more uplink SRSs using the first subset of antenna ports.

In some examples, the full port sounding procedure is associated with a first power level that is higher than a second power level associated with the partial port sounding procedure.

In some examples, the switching component 660 is capable of, configured to, or operable to support a means for receiving a fourth control signal indicating to switch from the partial port sounding procedure to the full port sounding procedure or from the full port sounding procedure to the partial port sounding procedure, where the fourth control signal includes a PDCCH message or a MAC-CE message.

In some examples, the control signal includes one of a MAC-CE or a DCI message.

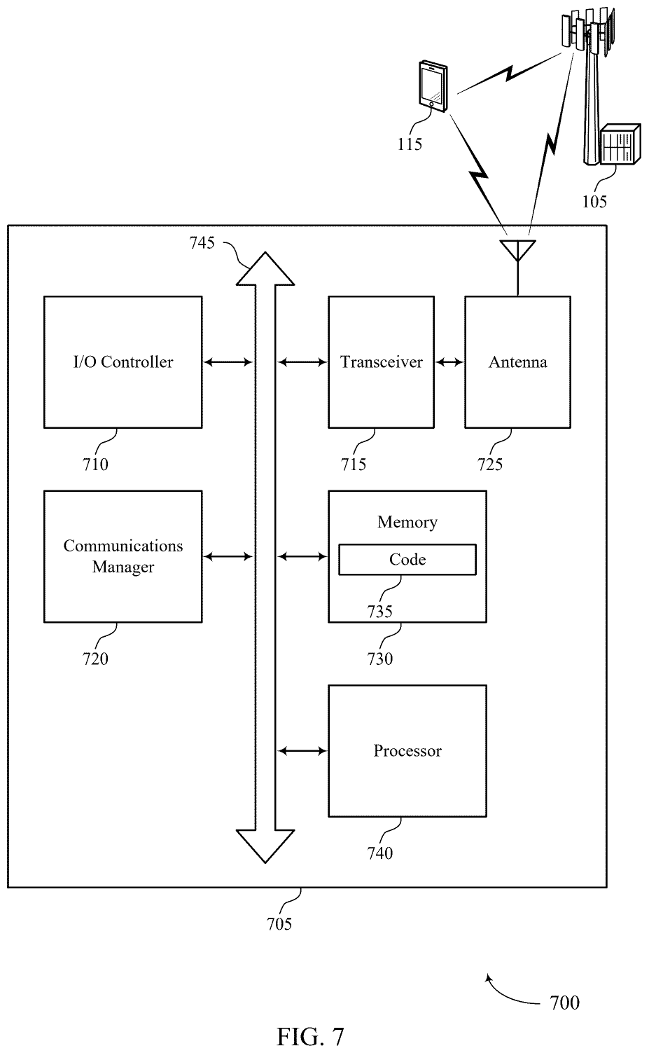

FIG. 7 shows a diagram of a system 700 including a device 705 that supports signaling for partial port sounding procedures in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting signaling for partial port sounding procedures). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a capability message indicating that the UE is capable of performing a partial port sounding procedure via a first quantity of antenna ports that is less than a second quantity of antenna ports for a full port sounding procedure associated with a total set of antenna ports of the UE. The communications manager 720 is capable of, configured to, or operable to support a means for receiving a control signal instructing the UE to perform the partial port sounding procedure using a first subset of antenna ports of the UE, where the control signal identifies the first subset of antenna ports from the total set of antenna ports according to the first quantity of antenna ports. The communications manager 720 is capable of, configured to, or operable to support a means for performing the partial port sounding procedure using the first subset of antenna ports in response to the control signal.

By including or configuring the communications manager 720 in accordance with examples as described herein, the device 705 may support techniques for reduced power consumption and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of signaling for partial port sounding procedures as described herein, or the at least one processor 740 and the at least one memory 730 may be otherwise configured to, individually or collectively, perform or support such operations.

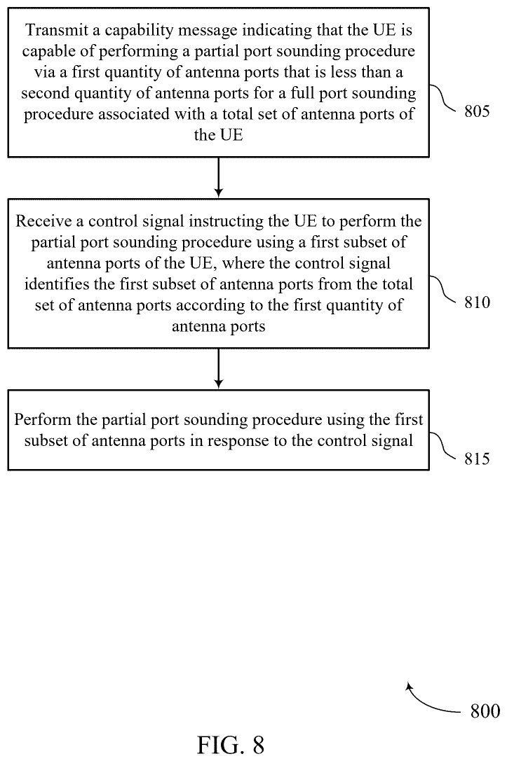

FIG. 8 shows a flowchart illustrating a method 800 that supports signaling for partial port sounding procedures in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting a capability message indicating that the UE is capable of performing a partial port sounding procedure via a first quantity of antenna ports that is less than a second quantity of antenna ports for a full port sounding procedure associated with a total set of antenna ports of the UE. The operations of 805 may be performed in accordance with examples as disclosed herein. In some examples, aspects of the operations of 805 may be performed by a capability message component 625 as described with reference to FIG. 6.

At 810, the method may include receiving a control signal instructing the UE to perform the partial port sounding procedure using a first subset of antenna ports of the UE, where the control signal identifies the first subset of antenna ports from the total set of antenna ports according to the first quantity of antenna ports. The operations of 810 may be performed in accordance with examples as disclosed herein. In some examples, aspects of the operations of 810 may be performed by a partial SRS instruction component 630 as described with reference to FIG. 6.

At 815, the method may include performing the partial port sounding procedure using the first subset of antenna ports in response to the control signal. The operations of 815 may be performed in accordance with examples as disclosed herein. In some examples, aspects of the operations of 815 may be performed by a partial SRS procedure component 635 as described with reference to FIG. 6.

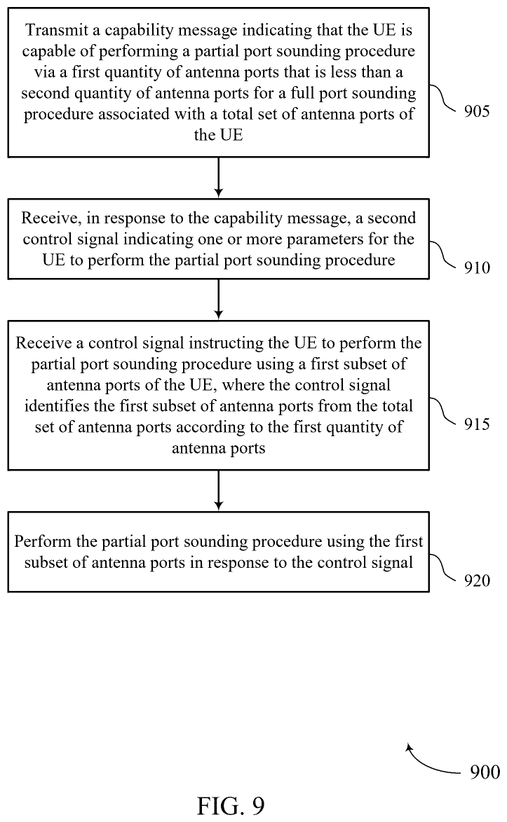

FIG. 9 shows a flowchart illustrating a method 900 that supports signaling for partial port sounding procedures in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include transmitting a capability message indicating that the UE is capable of performing a partial port sounding procedure via a first quantity of antenna ports that is less than a second quantity of antenna ports for a full port sounding procedure associated with a total set of antenna ports of the UE. The operations of 905 may be performed in accordance with examples as disclosed herein. In some examples, aspects of the operations of 905 may be performed by a capability message component 625 as described with reference to FIG. 6.

At 910, the method may include receiving, in response to the capability message, a second control signal indicating one or more parameters for the UE to perform the partial port sounding procedure periodically or aperiodically. The operations of 910 may be performed in accordance with examples as disclosed herein. In some examples, aspects of the operations of 910 may be performed by an SRS parameters component 640 as described with reference to FIG. 6.

At 915, the method may include receiving a control signal instructing the UE to perform the partial port sounding procedure using a first subset of antenna ports of the UE, where the control signal identifies the first subset of antenna ports from the total set of antenna ports according to the first quantity of antenna ports. The operations of 915 may be performed in accordance with examples as disclosed herein. In some examples, aspects of the operations of 915 may be performed by a partial SRS instruction component 630 as described with reference to FIG. 6.

At 920, the method may include performing the partial port sounding procedure using the first subset of antenna ports in response to the control signal. The operations of 920 may be performed in accordance with examples as disclosed herein. In some examples, aspects of the operations of 920 may be performed by a partial SRS procedure component 635 as described with reference to FIG. 6.

The following provides an overview of aspects of the present disclosure:

Aspect 1: A method for wireless communications by a UE, comprising: transmitting a capability message indicating that the UE is capable of performing a partial port sounding procedure via a first quantity of antenna ports that is less than a second quantity of antenna ports for a full port sounding procedure associated with a total set of antenna ports of the UE; receiving a control signal instructing the UE to perform the partial port sounding procedure using a first subset of antenna ports of the UE, wherein the control signal identifies the first subset of antenna ports from the total set of antenna ports according to the first quantity of antenna ports; and performing the partial port sounding procedure using the first subset of antenna ports in response to the control signal.

Aspect 2: The method of aspect 1, further comprising: receiving, in response to the capability message, a second control signal indicating one or more parameters for the UE to perform the partial port sounding procedure periodically or aperiodically.

Aspect 3: The method of any of aspects 1 through 2, further comprising: receiving, in response to the capability message, a second control signal instructing the UE to perform the full port sounding procedure using the total set of antenna ports of the UE periodically or aperiodically; and performing the full port sounding procedure periodically or aperiodically using the total set of antenna ports of the UE based at least in part on the second control signal.

Aspect 4: The method of any of aspects 1 through 3, further comprising: receiving, via a third control signal, an indication of a first periodicity associated with performing the full port sounding procedure and of a second periodicity associated with performing the partial port sounding procedure.

Aspect 5: The method of aspect 4, wherein the third control signal comprises an RRC message.

Aspect 6: The method of any of aspects 1 through 5, further comprising: receiving, in response to performing the partial port sounding procedure, a second control signal instructing the UE to perform the partial port sounding procedure using a second subset of antenna ports of the UE, wherein the second subset of antenna ports includes at least one antenna port different than the first subset of antenna ports; and performing the partial port sounding procedure using the second subset of antenna ports in response to the second control signal.

Aspect 7: The method of any of aspects 1 through 6, wherein performing the partial port sounding procedure comprises: muting a second subset of antenna ports of the UE, wherein the second subset of antenna ports is disjoint from the first subset of antenna ports.

Aspect 8: The method of any of aspects 1 through 7, wherein performing the partial port sounding procedure comprises: deactivating a subset of receive chains of a plurality of receive chains at the UE, wherein the subset of receive chains correspond to a second subset of antenna ports, wherein the second subset of antenna ports are different than the first subset of antenna ports used for transmission of SRSs.

Aspect 9: The method of any of aspects 1 through 8, wherein receiving the control signal comprises: receiving the control signal instructing the UE to perform the partial port sounding procedure based at least in part on a downlink buffer size being below a threshold buffer size, a downlink throughput being below a threshold downlink throughput, or both.

Aspect 10: The method of any of aspects 1 through 9, wherein the first subset of antenna ports associated with the partial port sounding procedure are based at least in part on an uplink SINR measurement per port associated with full port sounding.

Aspect 11: The method of aspect 10, wherein the first subset of antenna ports used for the partial port sounding procedure are associated with a higher uplink SINR measurement than a second subset of antenna ports muted for the partial port sounding procedure.

Aspect 12: The method of any of aspects 1 through 11, wherein performing the partial port sounding procedure comprises: transmitting one or more uplink SRSs using the first subset of antenna ports.

Aspect 13: The method of any of aspects 1 through 12, wherein the full port sounding procedure is associated with a first power level that is higher than a second power level associated with the partial port sounding procedure.

Aspect 14: The method of any of aspects 1 through 13, further comprising: receiving a fourth control signal indicating to switch from the partial port sounding procedure to the full port sounding procedure or from the full port sounding procedure to the partial port sounding procedure, wherein the fourth control signal comprises a PDCCH message or a MAC-CE message.

Aspect 15: The method of any of aspects 1 through 14, wherein the control signal comprises one of a MAC-CE or a DCI message.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability message indicating that the UE is capable of performing a partial port sounding procedure via a first quantity of antenna ports that is less than a second quantity of antenna ports for a full port sounding procedure associated with a total set of antenna ports of the UE;
receive a control signal instructing the UE to perform the partial port sounding procedure using a first subset of antenna ports of the UE, wherein the control signal identifies the first subset of antenna ports from the total set of antenna ports according to the first quantity of antenna ports; and
perform the partial port sounding procedure using the first subset of antenna ports in response to the control signal.

2. The UE of claim 1, wherein the one or more processors are individually or collectively further operable to execute the code to cause the UE to:
receive, in response to the capability message, a second control signal indicating one or more parameters for the UE to perform the partial port sounding procedure periodically or aperiodically.

3. The UE of claim 1, wherein the one or more processors are individually or collectively further operable to execute the code to cause the UE to:
receive, in response to the capability message, a second control signal instructing the UE to perform the full port sounding procedure using the total set of antenna ports of the UE periodically or aperiodically; and
perform the full port sounding procedure periodically or aperiodically using the total set of antenna ports of the UE based at least in part on the second control signal.

4. The UE of claim 1, wherein the one or more processors are individually or collectively further operable to execute the code to cause the UE to:
receive, via a third control signal, a configuration of a first periodicity associated with performing the full port sounding procedure and of a second periodicity associated with performing the partial port sounding procedure.

5. The UE of claim 4, wherein the third control signal comprises a radio resource control (RRC) message.

6. The UE of claim 1, wherein the one or more processors are individually or collectively further operable to execute the code to cause the UE to:
receive, in response to performing the partial port sounding procedure, a second control signal instructing the UE to perform the partial port sounding procedure using a second subset of antenna ports of the UE, wherein the second subset of antenna ports includes at least one antenna port different than the first subset of antenna ports; and
perform the partial port sounding procedure using the second subset of antenna ports in response to the second control signal.

7. The UE of claim 1, wherein, to perform the partial port sounding procedure, the one or more processors are individually or collectively operable to execute the code to cause the UE to:
mute a second subset of antenna ports of the UE, wherein the second subset of antenna ports is disjoint from the first subset of antenna ports.

8. The UE of claim 1, wherein, to perform the partial port sounding procedure, the one or more processors are individually or collectively operable to execute the code to cause the UE to:
deactivate a subset of receive chains of a plurality of receive chains at the UE, wherein the subset of receive chains correspond to a second subset of antenna ports, wherein the second subset of antenna ports are different than the first subset of antenna ports used for transmission of sounding reference signals (SRSs).

9. The UE of claim 1, wherein, to receive the control signal, the one or more processors are individually or collectively operable to execute the code to cause the UE to:
receive the control signal instructing the UE to perform the partial port sounding procedure based at least in part on a downlink buffer size being below a threshold buffer size, a downlink throughput being below a threshold downlink throughput, or both.

10. The UE of claim 1, wherein the first subset of antenna ports associated with the partial port sounding procedure are based at least in part on an uplink signal-to-interference noise ratio (SINR) measurement per port associated with full port sounding.

11. The UE of claim 10, wherein the first subset of antenna ports used for the partial port sounding procedure are associated with a higher uplink SINR measurement than a second subset of antenna ports muted for the partial port sounding procedure.

12. The UE of claim 1, wherein, to perform the partial port sounding procedure, the one or more processors are individually or collectively operable to execute the code to cause the UE to:
transmit one or more uplink sounding reference signals (SRSs) using the first subset of antenna ports.

13. The UE of claim 1, wherein the full port sounding procedure is associated with a first power level that is higher than a second power level associated with the partial port sounding procedure.

14. The UE of claim 1, wherein the one or more processors are individually or collectively further operable to execute the code to cause the UE to:
receive a fourth control signal indicating to switch from the partial port sounding procedure to the full port sounding procedure or from the full port sounding procedure to the partial port sounding procedure, wherein the fourth control signal comprises a physical downlink control channel (PDCCH) message or a medium access control (MAC)-control element (CE) message.

15. The UE of claim 1, wherein the control signal comprises one of a medium access control (MAC)-control element (CE) or a downlink control information (DCI) message.

16. A method for wireless communications by a user equipment (UE), comprising:
transmitting a capability message indicating that the UE is capable of performing a partial port sounding procedure via a first quantity of antenna ports that is less than a second quantity of antenna ports for a full port sounding procedure associated with a total set of antenna ports of the UE;
receiving a control signal instructing the UE to perform the partial port sounding procedure using a first subset of antenna ports of the UE, wherein the control signal identifies the first subset of antenna ports from the total set of antenna ports according to the first quantity of antenna ports; and
performing the partial port sounding procedure using the first subset of antenna ports in response to the control signal.

17. The method of claim 16, further comprising:
receiving, in response to the capability message, a second control signal indicating one or more parameters for the UE to perform the partial port sounding procedure periodically or aperiodically.

18. The method of claim 16, further comprising:
receiving, in response to the capability message, a second control signal instructing the UE to perform the full port sounding procedure using the total set of antenna ports of the UE periodically or aperiodically; and
performing the full port sounding procedure periodically or aperiodically using the total set of antenna ports of the UE based at least in part on the second control signal.

19. A non-transitory computer-readable medium storing code for wireless communications, the code comprising instructions executable by one or more processors to:
transmit a capability message indicating that a user equipment (UE) is capable of performing a partial port sounding procedure via a first quantity of antenna ports that is less than a second quantity of antenna ports for a full port sounding procedure associated with a total set of antenna ports of the UE;
receive a control signal instructing the UE to perform the partial port sounding procedure using a first subset of antenna ports of the UE, wherein the control signal identifies the first subset of antenna ports from the total set of antenna ports according to the first quantity of antenna ports; and
perform the partial port sounding procedure using the first subset of antenna ports in response to the control signal.

20. The non-transitory computer-readable medium of claim 19, wherein the instructions are further executable by the one or more processors to:
receive, in response to the capability message, a second control signal indicating one or more parameters for the UE to perform the partial port sounding procedure periodically or aperiodically.
